(19) United States
(12) Patent Application Publication
(10) Pub. No.: US 2017/0337494 A1
(43) Pub. Date: Nov. 23, 2017

(54) ZONE NAMING AND TAGGING BASED ON BEHAVIORS

(71) Applicant: International Business Machines Corporation, Armonk, NY (US)

(72) Inventors: Lisa Seacat DeLuca, Baltimore, MD (US); Jeremy A. Greenberger, Raleigh, NC (US)

(21) Appl. No.: 15/159,867

(22) Filed: May 20, 2016

(51) Int. Cl. G06Q 10/06

(52) U.S. Cl. CPC G06Q 10/0637

(57) ABSTRACT

Embodiments of the present invention provide systems and methods for naming and tagging zones. The method includes receiving a set of attributes and a map of a venue, and analyzing the set of attributes and map. The method further includes generating a list of names of the zones in the venue, and tags corresponding to the named zones, based on the set of attributes and the map of the venue.

### BACKGROUND OF THE INVENTION

The present invention relates generally to the field of location technology, and more particularly to naming zones and tags in a venue based on customer behaviors and trends.

A retail venue may be any physical location that facilitates the transfer of goods or services. When setting up retail venues, organizations often implement various zones in order to create groupings of such items as products, services, and marketing paraphernalia. These zones are often used for such purposes as creating a similar appearance across venues, grouping similar items, or spurring impulse buying. The establishment, organization, or reorganization of these zones can create issues for the venues, such as erroneous marketing campaign triggers, customer confusion, or incorrect product tagging.

### SUMMARY

According to one embodiment of the present invention, a method for zone naming and tagging is provided, the method comprising: receiving, by one or more processors, a set of attributes and a map of a venue; analyzing, by one or more processors, the set of attributes and the map of the venue; and generating, by one or more processors, a list comprising one or more zone names in the venue, and tags corresponding to the one or more zone names, wherein the list is based, at least in part, on the set of attributes and the map of the venue.

According to another embodiment of the present invention, a computer program product for zone naming and tagging is provided, based on the method described above.

According to another embodiment of the present invention, a computer system for zone naming and tagging is provided, based on the method described above.

### BRIEF DESCRIPTION OF THE DRAWINGS

FIG. 1 is a functional block diagram illustrating a data processing environment, in accordance with an embodiment of the present invention;

FIG. 2 is a flowchart illustrating operational steps for generating zone name and tag suggestions, in accordance with an embodiment of the present invention;

FIG. 3 is an example of a visualization of a venue map with zones, in accordance with an embodiment of the present invention; and

FIG. 4 is a block diagram of internal and external components of the computing device of FIG. 1, in accordance with an embodiment of the present invention.

### DETAILED DESCRIPTION

Many organizations and vendors, when arranging their venues, create locations to be mapped with “zones”, which are generally defined as an abstract area inside of a collection of points as defined by the venue operator. Zones typically represent a logical area in a venue that has some particular purpose, such as a department, counter, seating area, museum display, or airport terminal. Zone tags are generally smaller logical groupings and attributes associated with one or more zones, and may include such things as one or more products or product types, and marketing campaign triggers. Embodiments of the present invention provide systems and methods for utilizing data in order to formulate and suggest zone names and tags, analyze defined zone names and tags for mistakes, and suggest corrections if such mistakes were made.

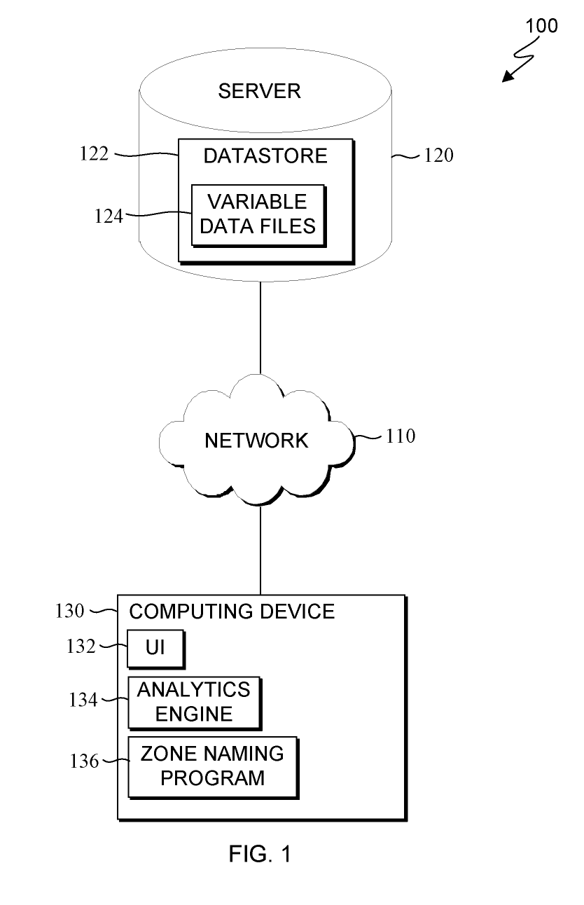

The present invention will now be described in detail with reference to the Figures. FIG. 1 is a functional block diagram illustrating a data processing environment, generally designated 100, in accordance with an embodiment of the present invention. Modifications to data processing environment 100 may be made by those skilled in the art without departing from the scope of the invention as recited by the claims. In an exemplary embodiment, data processing environment 100 includes server 120 and computing device 130, all interconnected over network 110.

Network 110 can be, for example, a local area network (LAN), a wide area network (WAN) such as the Internet, or a combination of the two, and can include wired, wireless, or fiber optic connections. In general, network 110 can be any combination of connections and protocols that will support communication and/or access between server 120 and computing device 130.

Server 120 includes datastore 122 and variable data files 124. In various embodiments of the present invention, server 120 can be a server computer system such as a management server, a web server, or any other electronic device or computing system capable of sending and receiving data, or any computing system utilizing one or more computers and components to act as a single pool of seamless resources.

Datastore 122 includes variable data files 124. In various embodiments of the present invention, datastore 122 can be a repository or a logical container, for persistently storing collections of data, such as a database, a file system, or a directory.

Variable data files 124 may include venue attributes, at least one of current and historic zone data, at least one of current and historic tag data, and data and attributes gathered from various sources, such as venue operators, customer attributes, and location-aggregators. In this exemplary embodiment, variable data files 124 are stored remotely in datastore 122. In another embodiment, variable data files 124 are stored locally, such as on computing device 130. In another embodiment, variable data files 124 may be stored in a combination of local and remote storage methods.

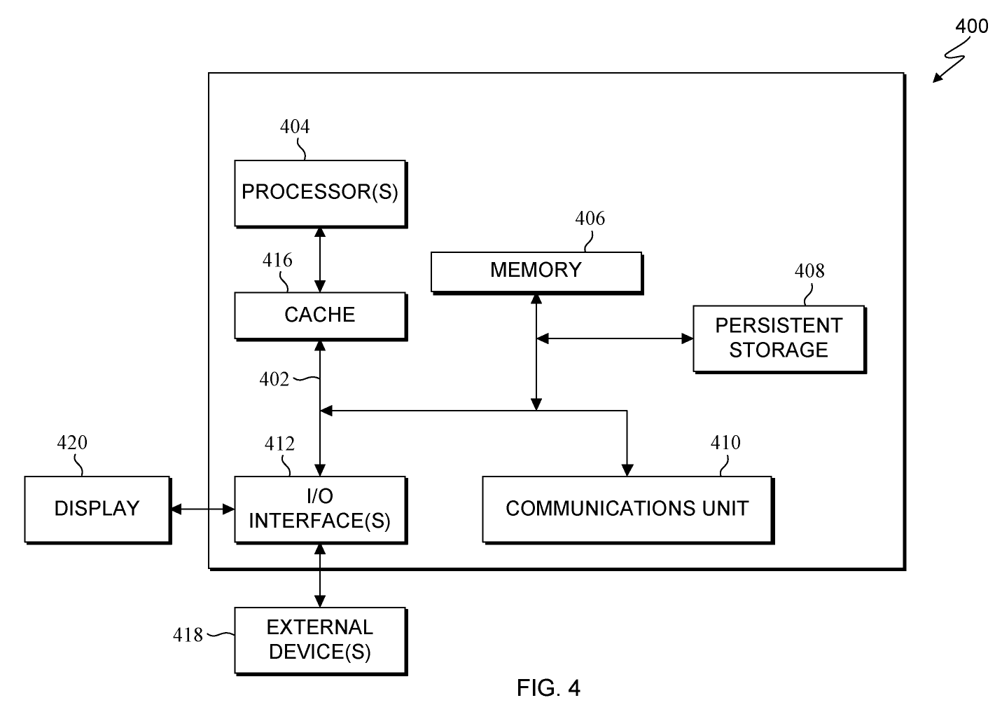

Computing device 130 includes user interface (UI) 132, analytics engine 134, and zone naming program 136. In various embodiments of the present invention, computing device 130 can be a laptop computer, a tablet computer, a netbook computer, a personal computer (PC), a desktop computer, a personal digital assistant (PDA), a smart phone, a thin client, or any programmable electronic device capable of executing computer readable program instructions. Computing device 130 may include internal and external hardware components, as depicted and described in further detail with respect to FIG. 4.

UI 132 may be, for example, a graphical user interface (GUI) or a web user interface (WUI) and can display text, documents, web browser windows, user options, application interfaces, and instructions for operation, and includes the information (such as graphic, text, and sound) a program presents to a user and the control sequences the user employs to control the program. UI 132 is capable of receiving data, user commands, and data input modifications from a user. UI 132 is also capable of communicating with analytics engine 134, and zone naming program 136.

Analytics engine 134 is a predictive analytics engine capable of aggregating and analyzing various types of data associated with zone names and tags. Types of data associated with zone names and tags may include, but are not limited to: customer dwell times, purchase history based on user paths, visitor count, popular tags from other venues in the parent organization, credit card transaction location, product scanning, and type of industry relative to the venue, such as a retail store, stadium, or restaurant. Analytics engine 134 is capable of aggregating and analyzing data associated with zone names and tags, from one or more venues, to understand such things as patterns and trends.

Zone naming program 136 is a software application capable of receiving information, such as variable data files 124, and data from analytics engine 134. Although depicted as a separate component, in one embodiment, zone naming program 136 may be partially or fully integrated with UI 132. In this exemplary embodiment, zone naming program 136 is capable of retrieving information via network 110. Zone naming program 136 is capable of receiving data from such sources as variable data files 124 and analytics engine 134, performing analysis on the data, determining zone names and tags for one or more venues, detecting new products or customer behaviors, and generating zone name and tag suggestions.

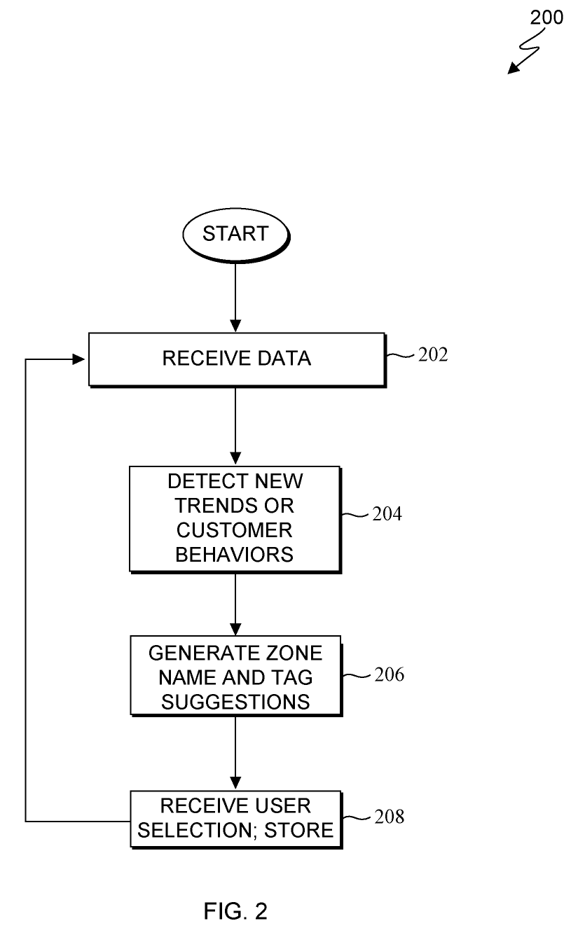

FIG. 2 is a flowchart 200 illustrating operational steps for determining and generating zone name and zone tag suggestions, in accordance with an embodiment of the present invention.

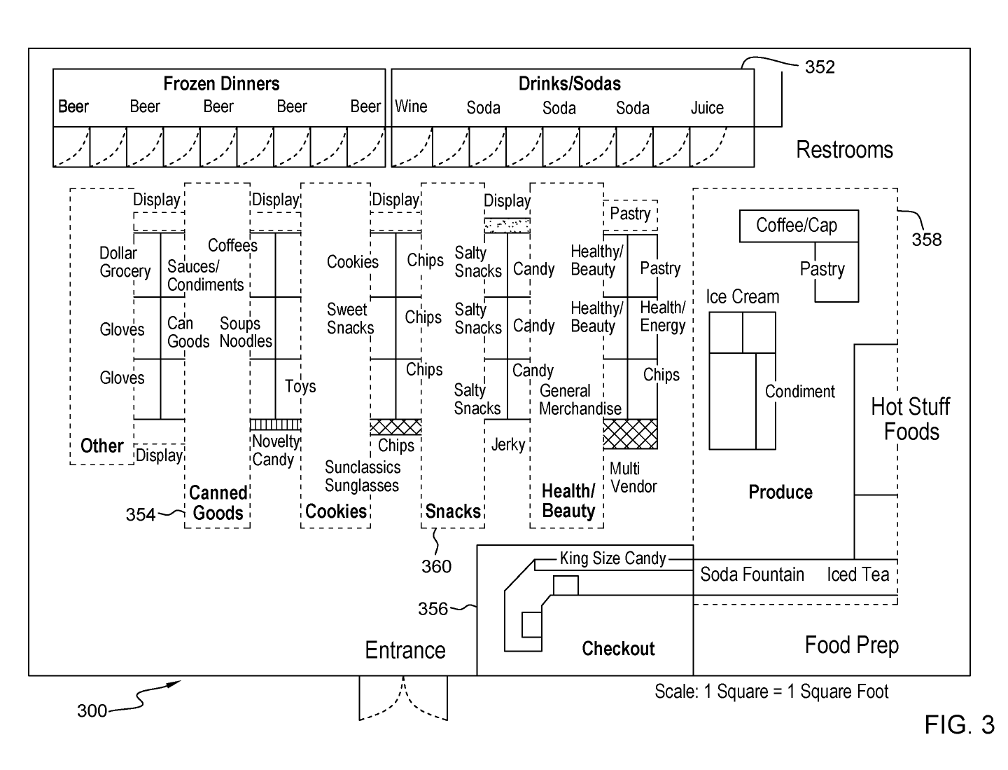

In step 202, zone naming program 136 receives data from a plurality of sources. The data received may include data manually input from one or more users, or data received from analytics engine 134. The data input from a user may include, but is not limited to: a floor plan for a venue, products and services in the venue, and zones drawn around one or more areas of interest in the venue (i.e., FIG. 3). Data from analytics engine 134 may include data from various sources, such as variable data files 124. In this exemplary embodiment, the data received from analytics engine 134 has been aggregated and analyzed for such purposes as connecting patterns of activity to understand behavior at a macro- and micro-segmentation level, to create a unified view of location activity, and to build context for analysis and action.

In step 204, zone naming program 136 detects new trends or customer behavior data, if available. The new trends or customer behavior data may include, but is not limited to: new products, products that were removed, misplaced products, inaccurate marketing campaign triggers, venue reorganizations, cognitive computing suggestions, requirements from venue operator, suggestions from marketers, changes in the industry relative to the venue, and customer behavior changes in such things as dwell times, purchase histories, credit card transaction locations, and products scanned.

In step 206, zone naming program 136 generates zone name and tag suggestions. In an exemplary embodiment, zone naming program 136 analyzes the new trends or customer behavior data received and compares new data to existing data and existing zone names and tags. Zone naming program 136 generates zone name and tag suggestions to the venue operator based on the analysis and comparison (i.e., FIG. 3). The generated suggestions may include, but are not limited to: a set or sets of zone names and tags to be added, zone names and tags to be removed, and zone names and tags to be reorganized.

In step 208, zone naming program 136 receives zone name and tag selections from the user and stores the selection. In an exemplary embodiment, once the suggestions have been generated and presented to the user, the user selections may be made by accepting or rejecting the suggestions manually. In another exemplary embodiment, user selections may be made by accepting or rejecting the generated suggestions automatically, based on a set of predetermined preferences. After the user has chosen the zone name and tag selections, either manually or automatically, from the generated suggestions, the chosen selections are saved to a database, such as datastore 122, and may be displayed to a user in a format such as the format depicted in FIG. 3. In some embodiments, once the set of zone names and tags is saved to the database, a user may interact with zone naming program 136 for suggested answers to a user query. User queries may include, but are not limited to: zone locations, the zone(s) in which a product, product group, or service is located in, new products, and new product locations. In an additional exemplary embodiment, probable suggestions to queries are proposed, even when a direct reference to a zone name or tag is not found for the user's query. An example of a probable suggestion when a direct reference to a zone name or tag is not found is if the user searches for the Candy zone in a venue, with no additional search information, but candy is not a predefined zone name for the venue. Through technology such as cognitive computing, zone naming program 136 determines that although there is no Candy zone, a user searching for a Candy zone is 90% likely to find what they are searching for in the Snacks zone and 10% likely to find what they are searching for in the Cookies zone, and returns these results to the user. Zone naming program 136 then continues to receive data (i.e., step 202).

FIG. 3 depicts a zone map 300, which, in accordance with an embodiment of the present invention, is a floor plan for a venue, including named products and services within the venue, zones drawn around areas of interest, and suggestions for zone names determined by zone naming program 136. In an exemplary embodiment, zone naming program 136 receives zone map 300 from the user, with zones drawn around areas of interest such as zone 352, 354, 356, and 358. Zone naming program 136 then generates zone names (i.e., step 206) such as Drinks/Sodas zone 352, Canned Goods zone 354, Checkout zone 356, and Produce zone 358, accepts or rejects zone map 300 based on user preferences, and stores zone map 300 (i.e., step 208). In another exemplary embodiment, a venue has cookies in Checkout zone 356, as well as in Snacks zone 360, and the venue decides that cookies are only to be in Snacks zone 360. The venue moves all cookies from Checkout zone 356 to Snacks zone 360. Zone naming program 136 recognizes the new data automatically, and updates the associated zone tag, based on the data received, by removing the cookies tag from Checkout zone 356. In an additional exemplary embodiment, a venue changes the layout of the venue by swapping Canned Goods zone 354 with Produce zone 358. Zone naming program 136 automatically recognizes the swap and updates the associated zone names and tags based on the new data. For instance, zone tags for a canned goods marketing campaign trigger, such as a buy-one-get-one-free deal on canned soups, are automatically associated with the new Canned Goods zone (i.e., the current location of the canned goods), and zone tags for a produce marketing campaign trigger, such as a daily special on raspberries and blackberries, are automatically associated with the new Produce zone (i.e., the current location of the produce). Since these zone names and tags are automatically updated, customers entering these zones can then automatically receive an alert for the marketing campaign trigger on a device synced to the zone naming program, such as a smart phone, based on factors such as the customer attributes associated with the specific customer, and the preset preferences of the venue. For instance, in the daily special on raspberries and blackberries and the buy-one-get-one-free deal on canned soups discussed above, a customer using a synced device, and who had previously purchased fruit but had never purchased canned soups from the venue, would automatically receive an alert on their synced device, while walking through the new produce zone. In this example, the alert indicates that there is a special on raspberries and blackberries. However, since the customer had never purchased canned soups, the customer may not receive an alert, while walking through the canned goods zone, that there is a deal on canned soups. In some embodiments, the determination as to whether the customer receives an alert is based, in part, on a degree of relatedness between a given product and products that have been purchased by the customer in the past. In continuation with the previous example, canned soup is determined to have a low degree of relatedness to raspberries and blackberries. Therefore, the customer does not receive the alert directed to the deal on canned soups. In some cases, the degree of relatedness between products is based on a statistical probability that a customer that has purchased, or is preparing to purchase, a first product would have an interest in a second product. In some cases, two products being included in one or both of the same category of products and zones results in a higher probability that a customer would be interested in both products. For example, in the daily special on raspberries and blackberries, a customer who has purchased blueberries, but has not purchased raspberries or blackberries, would receive the alert indicating the daily special on raspberries and blackberries since blueberries would generally be included in the same category of products and zones. In some cases, two or more products are often purchased together based on the uses of the products themselves. For example, in one scenario, the directions for use of an oven cleaner recommends the use of rubber gloves during application of the oven cleaner and, because of this recommendation, rubber gloves and oven cleaner are often purchased together. As such, even though the oven cleaner and rubber gloves are not in the same category of product or zone, their degree of relatedness is still determined to be above a threshold such that a customer receives alerts for both products when they select either product for purchase. Methods and techniques of (i) tracking items that have been selected by a customer for purchase, and (ii) communicating that information are understood by one skilled in the art.

FIG. 4 is a block diagram of internal and external components of a computer system 400, which is representative of the computer systems of FIG. 1, in accordance with an embodiment of the present invention. It should be appreciated that FIG. 4 provides only an illustration of one implementation and does not imply any limitations with regard to the environments in which different embodiments may be implemented. In general, the components illustrated in FIG. 4 are representative of any electronic device capable of executing machine-readable program instructions. Examples of computer systems, environments, and/or configurations that may be represented by the components illustrated in FIG. 4 include, but are not limited to: personal computer systems, server computer systems, thin clients, thick clients, laptop computer systems, tablet computer systems, cellular telephones (e.g., smart phones), multiprocessor systems, microprocessor-based systems, network PCs, minicomputer systems, mainframe computer systems, and distributed cloud computing environments that include any of the above systems or devices.

Computer system 400 includes communications fabric 402, which provides for communications between one or more processors 404, memory 406, persistent storage 408, communications unit 410, and one or more input/output (I/O) interfaces 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In general, memory 406 can include any suitable volatile or non-volatile computer-readable storage media. Software (e.g., zone naming program 136, etc.) is stored in persistent storage 408 for execution and/or access by one or more of the respective processors 404 via one or more memories of memory 406.

Persistent storage 408 may include, for example, a plurality of magnetic hard disk drives. Alternatively, or in addition to magnetic hard disk drives, persistent storage 408 can include one or more solid state hard drives, semiconductor storage devices, read-only memories (ROM), erasable programmable read-only memories (EPROM), flash memories, or any other computer-readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer-readable storage medium that is also part of persistent storage 408.

Communications unit 410 provides for communications with other computer systems or devices via a network (e.g., network 110). In this exemplary embodiment, communications unit 410 includes network adapters or interfaces such as a TCP/IP adapter cards, wireless Wi-Fi interface cards, or 3G or 4G wireless interface cards or other wired or wireless communication links. The network can comprise, for example, copper wires, optical fibers, wireless transmission, routers, firewalls, switches, gateway computers and/or edge servers. Software and data used to practice embodiments of the present invention can be downloaded to computing device 130 through communications unit 410 (e.g., via the Internet, a local area network or other wide area network). From communications unit 410, the software and data can be loaded onto persistent storage 408.

One or more I/O interfaces 412 allow for input and output of data with other devices that may be connected to computer system 400. For example, I/O interface 412 can provide a connection to one or more external devices 418 such as a keyboard, computer mouse, touch screen, virtual keyboard, touch pad, pointing device, or other human interface devices. External devices 418 can also include portable computer-readable storage media such as, for example, thumb drives, portable optical or magnetic disks, and memory cards. I/O interface 412 also connects to display 420.

Display 420 provides a mechanism to display data to a user and can be, for example, a computer monitor. Display 420 can also be an incorporated display and may function as a touch screen, such as a built-in display of a tablet computer.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to: an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for zone naming and tagging, the method comprising:
receiving, by one or more processors, a set of attributes and a map of a venue;
analyzing, by one or more processors, the set of attributes and the map of the venue; and
generating, by one or more processors, a list comprising one or more zone names in the venue, and tags corresponding to the one or more zone names, wherein the list is based, at least in part, on the set of attributes and the map of the venue.

2. The method of claim 1, further comprising:
receiving, by one or more processors, a user query for information;
executing, by one or more processors, an analysis of the user query, based in part on the list of one or more zone names and tags; and
generating, by one or more processors, an answer to the user query.

3. The method of claim 2, wherein the answer comprises:
one or more probable suggestions to the user query, responsive to determining no zone name or tag exists for the user query.

4. The method of claim 1, further comprising:
detecting, by one or more processors, a change to at least one of: the set of attributes, the one or more zone names, and the tags; and automatically generating, by one or more processors, at least one new zone name or at least one new tag, based on the detected change.

5. The method of claim 1, further comprising:
displaying, by one or more processors, the list of one or more zone names and tags to a user.

6. The method of claim 4, further comprising:
automatically receiving, by one or more processors, one or more selections from a user from the generated at least one new zone name or at least one new tag, based on predetermined user preferences; and
updating, by one or more processors, the list of zone names and tags with the one or more selections received from the user.

7. The method of claim 1, wherein the set of attributes comprises: customer dwell times, customer purchase histories based on user paths, visitor count, popular tags from other venues in the parent organization, type of industry relative to the venue, credit card transaction location, product scanning, product reorganization, customer trends, product locations, addition of new products, removal of products, historical venue data, locations within a venue, zone name suggestions, and zone tag suggestions.

8. A computer program product comprising:
a computer readable storage medium and program instructions stored on the computer readable storage medium, the program instructions comprising:
program instructions to receive a set of attributes and a map of a venue;
program instructions to analyze the set of attributes and the map of the venue; and
program instructions to generate a list comprising one or more zone names in the venue, and tags corresponding to the one or more zone names, wherein the list is based, at least in part, on the set of attributes and the map of the venue.

9. The computer program product of claim 8, further comprising:
program instructions to receive a user query for information;
program instructions to execute an analysis of the user query, based in part on the list of one or more zone names and tags; and
program instructions to generate an answer to the user query.

10. The computer program product of claim 9, wherein the answer comprises:
one or more probable suggestions to the user query, responsive to determining no zone name or tag exists for the user query.

11. The computer program product of claim 8, further comprising:
program instructions to detect a change to at least one of: the set of attributes, the one or more zone names, and the tags; and
program instructions to automatically generate at least one new zone name or at least one new tag, based on the detected change.

12. The computer program product of claim 8, further comprising:
program instructions to display the list of one or more zone names and tags to a user.

13. The computer program product of claim 11, further comprising:
program instructions to automatically receive one or more selections from a user from the generated at least one new zone name or at least one new tag, based on predetermined user preferences; and
program instructions to update the list of zone names and tags with the one or more selections received from the user.

14. The computer program product of claim 8, wherein the set of attributes comprises: customer dwell times, customer purchase histories based on user paths, visitor count, popular tags from other venues in the parent organization, type of industry relative to the venue, credit card transaction location, product scanning, product reorganization, customer trends, product locations, addition of new products, removal of products, historical venue data, locations within a venue, zone name suggestions, and zone tag suggestions.

15. A computer system comprising:
one or more computer processors;
one or more computer readable storage media;
program instructions stored on the one or more computer readable storage media for execution by at least one of the one or more processors, the program instructions comprising:
program instructions to receive a set of attributes and a map of a venue;
program instructions to analyze the set of attributes and the map of the venue; and
program instructions to generate a list comprising one or more zone names in the venue, and tags corresponding to the one or more zone names, wherein the list is based, at least in part, on the set of attributes and the map of the venue.

16. The computer system of claim 15, further comprising:
program instructions to receive a user query for information;
program instructions to execute an analysis of the user query, based in part on the list of one or more zone names and tags; and
program instructions to generate an answer to the user query.

17. The computer system of claim 16, wherein the answer comprises:
one or more probable suggestions to the user query, responsive to determining no zone name or tag exists for the user query.

18. The computer system of claim 15, further comprising:
program instructions to detect a change to at least one of: the set of attributes, the one or more zone names, and the tags; and
program instructions to automatically generate at least one new zone name or at least one new tag, based on the detected change.

19. The computer system of claim 15, further comprising:
program instructions to display the list of one or more zone names and tags to a user.

20. The computer system of claim 18, further comprising:
program instructions to automatically receive one or more selections from a user from the generated at least one new zone name or at least one new tag, based on predetermined user preferences; and
program instructions to update the list of zone names and tags with the one or more selections received from the user.
